(19) United States
(12) Patent Application Publication
(10) Pub. No.: US 2014/0035480 A1
(43) Pub. Date: Feb. 6, 2014

(54) METHOD FOR THE CONTROL OF LUMINANCE OF GAS DISCHARGE LAMPS

(71) Applicants: Tsvi Blumin, Maagan Michael (IL); Emil Blumer, Haifa (IL)

(72) Inventors: Tsvi Blumin, Maagan Michael (IL); Emil Blumer, Haifa (IL)

(21) Appl. No.: 13/565,438

(22) Filed: Aug. 2, 2012

(51) Int. Cl. H05B 41/36

(52) U.S. Cl. 315/287

(57) ABSTRACT

A system for the control of luminance of a gas-discharge lamp, which includes a variable frequency drive (VFD) accepting AC voltage supply. The VFD is has a constant ratio of frequency to AC voltage ratio of the output. Raising the frequency of the output of the VSD would result in an equivalent rise in the voltage. Typically, a ballast on the input AC of the lamp is required and the power factor correction capacitor usually associated with the lamp is to be removed.

### FIELD OF THE INVENTION

The present invention relates to the control of luminance of gas-discharge lamps and the use of apparatus for such application.

### BACKGROUND OF THE INVENTION

The role of lamps is to illuminate a certain location, be it an indoor space or an outdoors environment, so as to make objects discernible to the observers. Ambient light however is subject to changes over time, sometimes quite rapidly and typically following a diurnal cycle of natural light intensity change. Artificial light is intended to compensate for the lack of natural light during dark hours of the day, in dark places, or for many other local reasons. For implementing control over the Illumination, it is required to increase or decrease the amount of illuminating elements, e.g. lamps, or change the luminance of existing ones, or both.

Gas discharge lamps are light sources that are often used for general purpose lighting, both indoor, such as in homes, houses, industrial spaces, as well as outdoors e.g. street lighting. In such devices, the illumination is produced as the free electrons accelerated by the electric field inside the lamp collide with gas atoms and other atoms inside the lamp. The collision causes electrons in orbit to jump to a higher energy state. When such electrons revert to their original state, energy is released in the form of light. Typically noble gasses are used for such lighting, xenon, neon, helium and argon are mostly used or some combination thereof. When the electrons are accelerated in an electric field through the gas ions, some electrons are raised to a high level of energy and when they return to their basic level of energy, the surplus energy is discharged in the form of photons, sensed by the eyes as light.

The gas discharge lamps are also referred to as electric discharge lamps, vapor lamps, and more rarely just as discharge lamps. In addition to the noble gas, metals or metal salts may be added to the container in which the gas is disposed. Typically, gas discharge lamps operate more efficaciously at higher frequency AC input. In order to prevent self-destruction, gas discharge lamps employ a ballast, referred to also as choke, which contains a coil, usually wound over iron core. The ballast may be integral with the lamp or it physically placed outside of the lamp and connected electrically to the lamp.

### SUMMARY OF THE INVENTION

A system for the control of luminance of a gas-discharge lamp, which includes a variable frequency drive (VFD) accepting AC voltage supply. The VFD is has a constant ratio of frequency to AC voltage ratio of the output. Raising the frequency of the output of the VSD would result in an equivalent rise in the voltage. Typically, a ballast on the input AC of the lamp is required and the power factor correction capacitor usually associated with the lamp is to be removed.

### BRIEF DESCRIPTION OF THE DRAWINGS

The invention may be understood upon reading of the following detailed description of non-limiting exemplary embodiments thereof, with reference to the following drawings, in which:

FIG. 1 is a schematic description of the fundamental modules of a luminance control system, in accordance with the instant invention;

FIG. 2 is a schematic description of a pulse width modulation control over output frequency;

FIG. 3 is a schematic description of service programs and their function within the framework of the command module; and

FIG. 4 is a schematic description of exemplary inputs provided to a service program.

The following detailed description of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

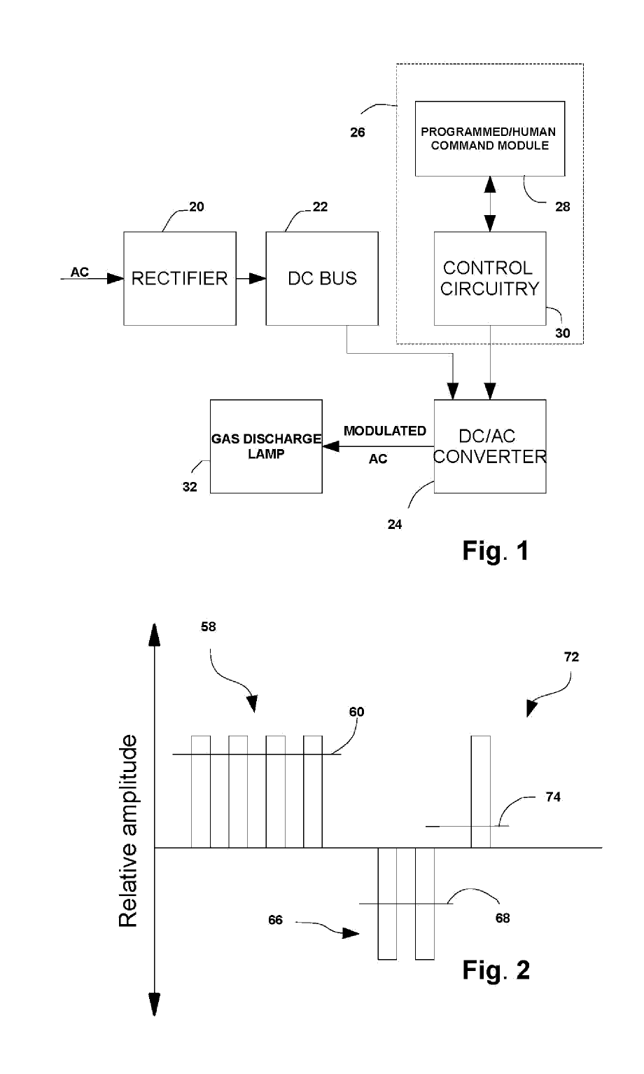

In accordance with the present invention, the luminance of a gas discharge lamp is controlled by a device otherwise used for driving AC electric motors. The concept of control of luminance used hereinafter means the change, reduction or increase of luminous intensity. The term driving is used hereinafter, as known in the art, to define the ability to control the rotational speed of an AC electric motor. More specifically, the device used in accordance with the present invention is a variable frequency drive (VFD), also known as variable voltage variable frequency drive. In VFD the ratio between the output voltage and output frequency that feeds the motor is kept constant. As can be seen in FIG. 1 to which reference is now made, rectifier module 20, receiving constant AC power supply, rectifies the voltage, smoothes it out and feeds it to DC bus 22. The current is modified by a DC/AC converter 24 by modulating it as will be dwelt upon in some detail further below. Control sub-unit 26 includes programmable/human command module 28 and control circuitry to regulate the functionality of converter 24. Gas discharge lamp 32 is fed modulated AC current. In accordance with the present invention, the power factor correction condenser of the gas discharge lamp, if present, is removed in order for the control by a system as described above to take place. If such power factor correction condenser is not installed in the gas discharge lamp circuitry, then applying the system of the invention obviates the use of such a correction condenser.

One prevalent variant of the VFD is the pulse width modulation (PWM) technique for voltage output control. PWM drives are well known in the art for applying control over the speed and frequency of power tolls, as can be seen in U.S. Pat. No. 6,696,814, the contents of which are incorporated herein by reference. In this method, the DC/AC converter uses switching to form a quasi-alternating current. The switches are in implemented as thyristors, bipolar transistor devices or transistorized devices or as IGBTs, for more details see for example U.S. Pat. No. 6,462,974, the contents of which are incorporated herein by reference. The control over the output voltage is not a closed loop circuit, and a change of the output voltage level, negative or positive, is approximated by the switching only. As a schematic description of the above discussed matter, as can be seen in FIG. 2, the series of positive switching-on, each described by a rectangle in zone 58, provides an average output voltage level as described by line 60. A series of negative switching-on as in zone 66 provides a negative voltage value 68 which is smaller in absolute amplitude. In zone 72, the switch was turned on only for a very few times, providing for a low absolute voltage level 74 as compared to levels 68 and 60. In PWM, the length of time that the switches are turned on is constant, and thus the control over the output voltage level is determined solely by the rate of the switches turned on/off. Currently, PWM technology utilizes insulated gate bipolar transistors (IGBTs) permits very high switching rate, such as 1-20 KHz, allowing for very high resolution of the change in amplitude of the output wave, for obtaining a smooth quasi-sinusoidal output wave.

### Programming and Applying Control Over the Luminance of the Gas Discharge Lamps

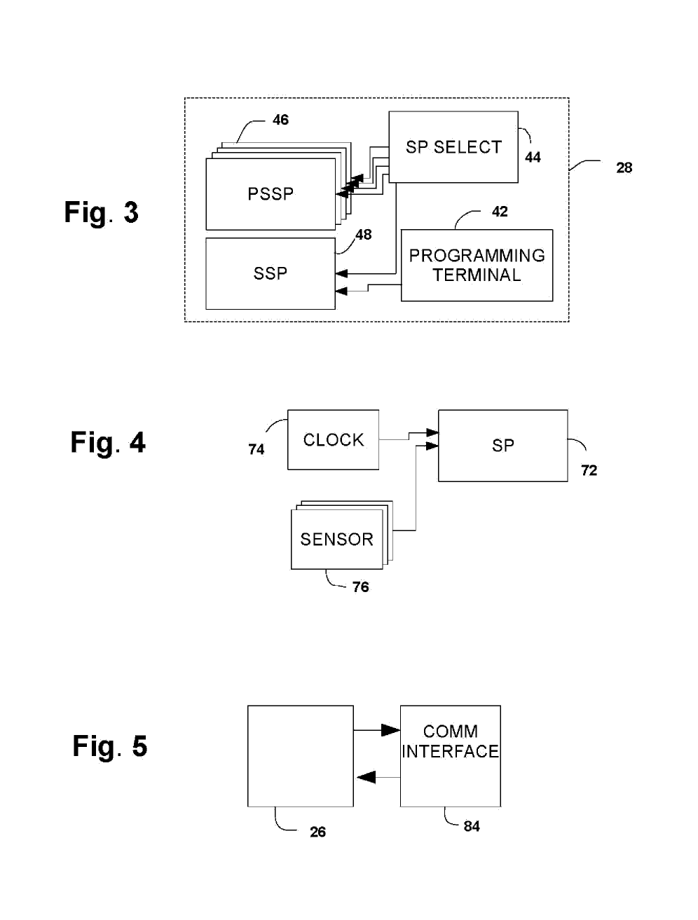

In VFD, the output voltage, and the waveform in general can be controlled by pre-programming or on-line for several AC voltage output rates and programs, such as gradual increase or decrease of amplitude. As mentioned above the modern PWM circuits employing IGBT lend themselves to easy and accurate control over voltage supply by the PWM circuit. As such, the PWM circuitry does not offer a full feedback controlled voltage supply loop. However, for the sake of keeping track of required illumination levels, a light sensor can be added to complete the loop. To help explain the implementation of the service programming in the framework of the command module, reference is first made to FIG. 3, exemplifying a specific combination of some of the command module's structural sub-units. Command module 28 includes a programming terminal 42, which can either be local or an external computer linked to command module 28. Service program select key 44 is a selection terminal connected to a set of pre-stored service programs (PSSPs) 46 and to one or more storable service programs (SSP) 48 produced by the user using programming terminal 42 at his/her desire. The programming terminal may be used to change parameters in existing PSSP. The PSSPs are stored in a non-volatile memory such a hard disc, flash memory or EPROM and the SSP is also storable upon request of the user, in the same place, typically. This/these memories are connected to a processor on which the programs run. As can be seen in FIG. 4 to which reference is now made, the service program 72, preprogrammed or else, derives clock data (time) from clock 74, and optionally signals from sensor/s 76, connected through an adapter (not shown) to the processor on which service program (SP) 72 runs.

The term service control in the context of the present invention relates to illumination specific applications associated with luminance control. A pre-supplied set of programs that are intended to offer alternative illumination features, such as for different lamp types or different lighting regimes is the PSSP and SSP. Typically the producer of the VFD provides also a human/programmed command module that facilitates manual or automated control of the electro-mechanical load by the VFD. In the context of the present invention, additional services are provided to accommodate the VFD to its usage in the control application over the luminance driven by the VFD. An example of usage of such automated control, is the application of different lighting regimes employing respective different voltage output levels, set for different hours of the day. For example, a sensor connected to the processor running an SP senses that natural luminance is low, and that the lamp or lamps such a s street lamps are to be turned on. The SP would wait for, say 15 minutes, getting clock pulses, to preclude the influence induced by a passing cloud, after which, if darkness prevails, the VFD would start turning on the associated lamp at a gradual controlled rate until full programmed luminance is obtained. Lights can be turned on at a fixed hour, such as four in the morning. Another example is a working room in which lights are to be turned on at a fraction luminance during the day and luminance is raised during night hours. User intervention may be applied as long as the program permits. Yet another example is an infrared motion sensor, that detects the presence of a person entering a room, in such an example, the entrance invokes the SP to start a cascade of events that leads to automatic illumination of a room, or hallway. The examples portrayed above demonstrate an important aspect of the implementation of a system of the invention. The carefully planned reduction or increase in luminous intensity is conducive to energy saving strategy of power usage.

Since gas discharge lamps are inherently different than electromechanical loads, some limitations may be inserted into the service programs in order to prevent damages to the lamps/ballast and other electronic components of the illumination hardware. In case the original program parameters of the producer of the VFD may be found to be unacceptable with respect to current parameters supplied to the lamp, or else be found too limiting, change may be require. In order to adapt the VFD to the control/drive of the gas discharge lamp, some experimentation may be required in order study the security and or efficiency aspects of the current parameters and possible limitations bestowed by the VFD.

In another aspect of the invention a communications interface is installed. As can be seen in FIG. 5, control sub-unit 26 is connected to a communications sub-unit 84 which is capable of receiving, sending and processing of data, digital or analog, or both, wired or wireless, to and from the control sub-unit. Implementing the communications aspect of the invention, permits turning illumination on or off from a distant location, without the need to actually physically contact the lamp. Else, it is possible to remotely select a specific pre-stored service programs. The communications interface is able to send to a control center data regarding functionality or condition of the lamp.

### Three Phase, Single Phase and Other Input Applications

An arrangement in accordance with the present invention is applicable for three phase AC line and a single phase line voltage. The AC line used dictates the architecture of the rectifier circuit. For each phase two solid state rectifiers are required, and for the output switching, for each phase an equal set of switches is required. An advantage of the system of the invention stems from the fact that any AC or DC source that can feed the DC bus (see FIG. 1) can be used to supply electrical energy to the device of the invention. The advantage is evident also in cases of failure or partial failure of the source line. In case of failing of one or two phases out of the three phases, the DC bus may continue functioning and either a single phase or three phase supply continue to flow at the output of the system, depending on the architecture of the DC/AC converter. Moreover the system of the invention may use DC supply instead of AC supply, if the DC bus 22 is fed directly by external DC.

The system of the invention can also be used for emergency lighting energy supply. To such an end, for example, a battery is connected to DC bus 22 using a relay, such that when the mains AC supply fails, the relay connects the battery to DC bus 22 to feed converter 24.

In another aspect of the present invention, it has been shown experimentally that using the system of the invention can shorten the time the illuminations starts. In gas discharge lamps, typically a period of time passes since turning on the switch and the actual illumination begins. The implementation of a VFD in accordance with the invention can shorten the time to full illumination considerably.

What is claimed is:

1. A system for controlling luminance of a gas-discharge lamp, the system comprising:
a VFD controller of an AC motor, connected to said gas discharge lamp;
a ballast connected to said lamp; and
a control sub-unit adapted to control the voltage output level of said VFD controller.

2. The system of claim 1, wherein said controller is also a pulse width modulation device.

3. The system of claim 1, wherein said control sub-unit includes a programmable/human command module.

4. The system of claim 3, further comprising a set of pre-stored service programs adapted to be selectable by a user.

5. The system of claim 3, further comprising a programming terminal for adding service programs or changing parameters in existing programs.

6. The system of claim 1, wherein said VFD controller is fed by AC input power.

7. The system of claim 1, wherein said VFD controller is fed by DC input power.

8. A method for applying control of luminance of a gas-discharge lamp, said method comprising:
supplying voltage over a DC bus to a DC/AC converter;
modulating said AC/DC converter such that the ratio between the output voltage and output frequency is kept constant; and
regulating the functionally of the converter with a control module.

9. The method of claim 8, wherein said modulating is carried out implementing a pulse width modulation (PWM) technique for voltage output control.
